(19) United States
(12) Patent Application Publication
(10) Pub. No.: US 2014/0337180 A1
(43) Pub. Date: Nov. 13, 2014

(54) BEST-DEAL LIST GENERATION

(71) Applicants: Martin Dvorak, Prague (CZ); Jakub Travnik, Prague (CZ); Juraj Kojdjak, Zilina-Banova (SK)

(72) Inventors: Martin Dvorak, Prague (CZ); Jakub Travnik, Prague (CZ); Juraj Kojdjak, Zilina-Banova (SK)

(21) Appl. No.: 14/374,486

(22) PCT Filed: Jan. 29, 2012
(86) PCT No.: PCT/US2012/023057

§ 371 Date: Jul. 24, 2014

(51) Int. Cl. G06Q 30/06

(52) U.S. Cl. CPC G06Q 30/0629; G06Q 30/0627
USPC 705/26.63

(57) ABSTRACT

In response to receipt of a best-deal request specifying requested feature levels for products, feature sufficiency for each of said products is evaluated. Each feature sufficiency indicates whether or not a given product meets a respective requested feature level. Normalized prices are determined for the products. Products are sorted according to feature sufficiency and normalized prices for the respective products. A best-deal list is generated with product identifiers for the products arranged in the sorted order.

### BACKGROUND

Cloud computing provides for convenient, on-demand network access to a shared pool of computing resources (e.g., networks, servers, storage, applications, and services) with minimal management effort or service-provider interaction. Examples of services provided via cloud computing can include office applications, storage, security, and collaboration. Cloud computing provides for flexible supplement to consumer-owned computing resources. Cloud computing vendors are increasingly providing a variety of cloud-based services using a variety of pricing models and levels to appeal to a variety of consumers.

### BRIEF DESCRIPTION OF THE DRAWINGS

The following figures represent examples and not the invention itself.

FIG. 1 is a schematic diagram of best-deal tool in accordance with an example.

FIG. 2 is a flow chart of a best-deal process in accordance with an example.

FIG. 3 is a schematic diagram of another best-deal tool in accordance with an example.

FIG. 4 is a screen shot of a best-deal list generated using the tool of FIG. 3.

FIG. 5 is a flow chart of a best-deal process implementable using the tool of FIG. 3 and in accordance with an example.

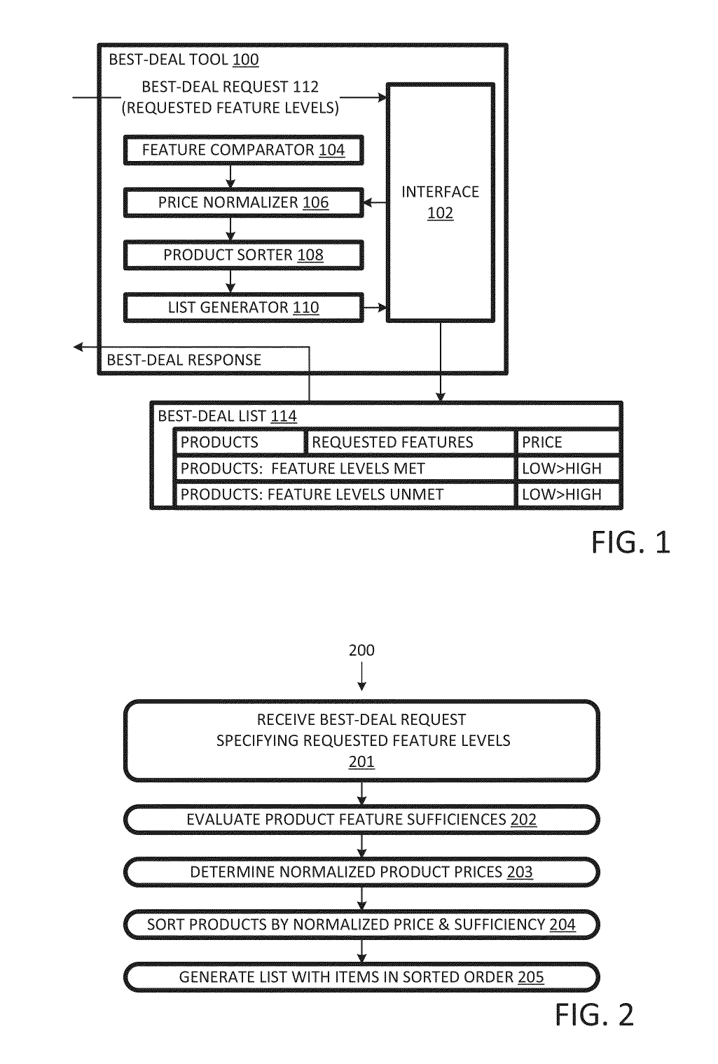

### DETAILED DESCRIPTION

Whether one is dealing with cloud computing or some other product category, finding a best value (deal) for a consumer can be a challenge where there is a broad selection of products and associated pricing plans and levels. A best-deal tool 100 addresses this challenge by responding to a best-deal request by returning a list of products ordered to make it easy for a consumer to determine which products represent the best deal. Best-deal tool 100 is a required-value-for-best-price metrics-base tool. Best-deal tool 100 can be used for economically filling gaps in an existing product portfolio and for enhancing an existing portfolio by replacing existing services with services that offer better value.

Best-deal tool 100 includes an interface 102, a feature comparator 104, a price normalizer 106, a product sorter 108, and a list generator 110. Interface 102 is to receive a best-deal request 112 specifying requested feature levels and to return a best-deal response in the form of a best-deal list 114. Feature comparator 104 responds to the requests evaluating products for feature sufficiency based on the extent to which products meet requested feature levels.

Price normalizer 106 sets normalized prices for products based on their respective vendor prices (which may reflect different and difficult-to-compare pricing models). Product sorter 108 sorts products (i.e., sorts corresponding product identifiers) based at least in part on normalized prices and feature sufficiency. List generator 110 generates a list, e.g., to be returned to the consumer making the best-deal request, with products listed in the sorted order.

Best-deal tool 100, feature comparator 104, price normalizer 106, product sorter 108, and list generator 110 are programmed hardware. In other words, they are constituted by a combination of hardware and software including: storage media encoded with code defining the functionality of the tool and components; and a processor to execute the code.

Best-deal tool 100 provides for implementing a process 200, flow charted in FIG. 2. At 201, a best-deal request is received specifying requested feature levels. In response, at 202, product feature sufficiencies are evaluated to indicate how the features of each product compare to requested feature levels. At 203, the normalized product prices are determined so that they can be compared despite different pricing models. At 204, products are sorted based at least in part on normalized prices and feature sufficiency. At 205, a list is generated with product identifiers in the sorted order.

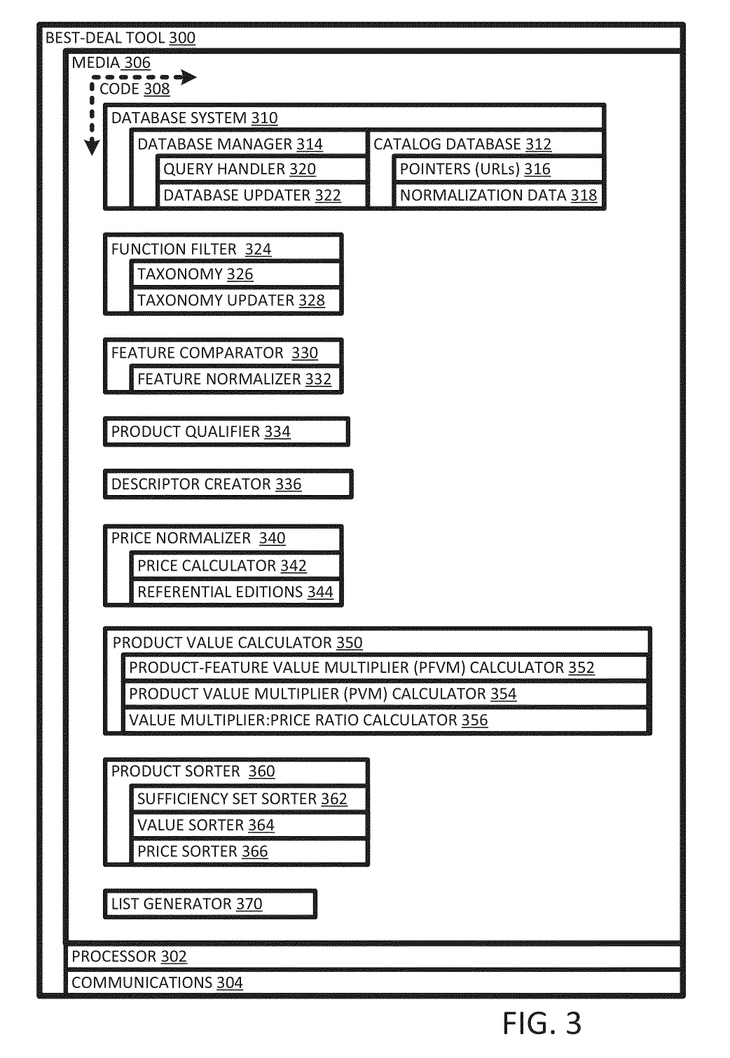

Typically, the products nearer the head of the list conform to the requesting consumer's preferences better than do the products lower on the list, with the product at the head of the list representing the best deal as determined by the best-deal tool. However, a consumer may be influenced by factors not adequately (or at all) captured by the list to choose a product other than the nominally best deal. Some of these factors are dealt with explicitly in the example of FIG. 3.

While alternative examples address other product and service marketplaces, best-deal tool 300 is directed at cloud services. Best deal tool 300 includes a processor 302, communications (including input-output) devices 304, and computer-readable storage media 306. Media 306 is encoded with code 308 that defines the functionality of programmed hardware best-deal tool 300 and its programmed hardware components.

Best-deal tool 300 includes a cloud-services database system 310, which includes a cloud-services price database 312 and a price database manager 314. Cloud-services price database 312 includes pointers 316, e.g., URLs (Uniform Resource Locators) to vendor price lists, including catalogs, for different cloud service vendors and product groups. Pointers 316 can refer to, for example, locations of price lists on vendor websites or to copies of vendor price lists in a local repository. Price database 312 can also include normalized data 318 including normalized prices and formulae for calculating normalized prices given quantities and other features specified in a best-deal request. Price database manager 314 includes a query handler 320 for handling queries to price database 312 and an updater 322 that is used for ensuring that the data in price database 312 is up-to-date.

Cloud services consumers typically have one or more functions in mind when seeking cloud services. Different products typically belong to different functional domains, e.g., word-processing versus image editing. Best-deal tool 300 has a function filter 324 that responds to best-deal requests by selecting products that provide the specified functionality and excluding products that do not. To this end, function filter 324 maintains and utilizes an extensible community-based function taxonomy 326 to help determine which products provide the specified functionality.

Function filter 324 further includes a taxonomy updater 326. Function taxonomy 326 identifies terms, including synonyms and functional equivalents, associated with functions that a consumer may specify. Taxonomy updater 328 allows community inputs suggesting additions and modifications to taxonomy 326. A taxonomy administrator may determine which community inputs to incorporate in taxonomy 326.

Feature comparator 330 of tool 300 compares product feature levels (PFLs) with requested feature levels (RFLs) to evaluate feature sufficiency for each product. A best-deal request can specify requested features and feature levels. Feature comparator 300 determines for each functionally qualified product whether or not a feature is present or missing in the product description.

If the feature for which a requested level has been specified is is present, feature comparator 300 determines whether the requested level is met (sufficient) or unmet (insufficient). If a requested feature level is met (sufficient), feature comparator determines whether the feature level is minimally sufficient or extra-sufficient; in the latter case, a further determination may be made of the degree to which a product feature level exceeds a corresponding requested feature level. If a product feature level is insufficient, feature comparator 300 determines the extent to which the requested feature level is insufficient. As different vendors may express features in different units and terms, feature comparator 330 includes a features normalizer 332 to express features in a common feature taxonomy and in common units.

Product qualifier 334 of tool 300 determines which products to include in the list to be returned to the requesting consumer. For example, product qualifier 334 may exclude products with no matching features. Product qualifier 334 may exclude other products, e.g., products that do not meet any of the requested feature levels. The criteria for a qualified product may depend on the numbers of more qualified products. For example, whether or not products failing to meet any requested feature level may be included in the returned results may depend on the number of products that meet all or some of the requested feature levels.

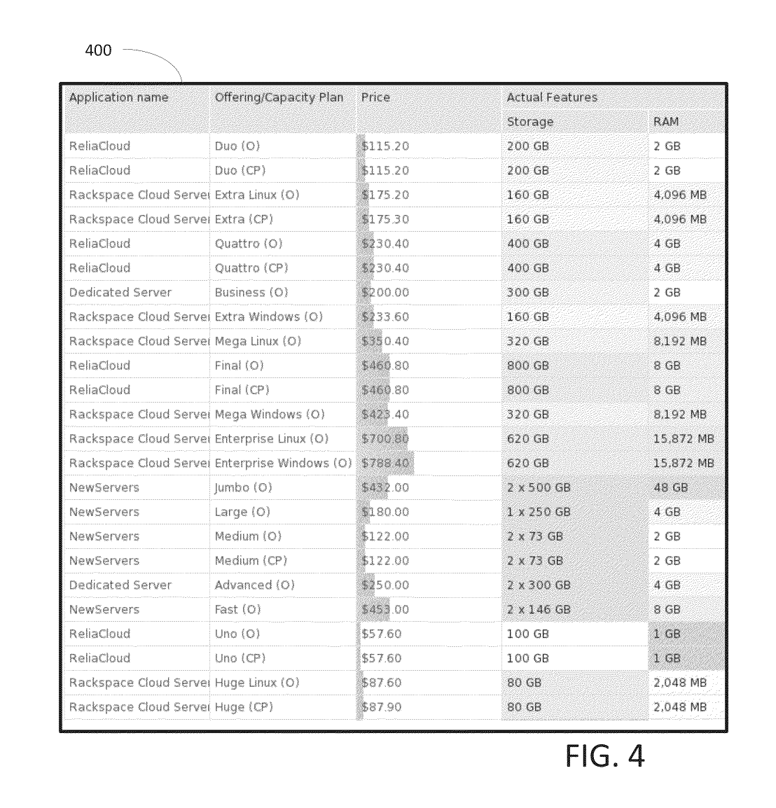

Descriptor creator 336 of tool 300 provides comparative descriptions for each of the qualified products. The descriptions can specify the vendors' product name or names (e.g., application and edition), pricing model, matching features, under-satisfied features, over-satisfied features, missing features and (unrequested) extra features. Some or all of these descriptors may be used in a best-deal list, e.g., list 400 of FIG. 4, returned by tool 300.

Cloud service vendors typically offer a service under a pricing is model that offers one or more “products” (aka, “editions”), with each product having a vendor list price that represents an offer. Vendors use different pricing models: for example, subscription—fixed price for a fixed number of accounts and time period.; pay-per-account—the price is based on the number of accounts; pay as you go (use based)—the price is based on the actual capacity of resources used (i.e. it is post-paid).

Vendor price lists are available in miscellaneous formats and vendor specific structure. In order to be able to process them, a mapping and a conversion. method must be found. A vendor price list is usually formed by a subscription period (depending on pricing strategy) and a set of (configurable) features that might require extra charge. A feature on the vendor price list might have various properties and parameters. Apart to feature name it might be feature level, quantity, limit, unit, etc.

Price normalizer 340 of tool 300 assigns normalized prices to qualified products; the normalized prices can be readily compared despite different pricing plans in the vendors' price lists. A service might have several products and each product may be described by a respective vendor price list. The vendor lists may specify the offer pricing model, billing and list of features. In some cases, vendor prices can be taken as is from vendor price lists. However, in many cases, price may vary as features are added, deleted, upgraded, and downgraded to match requested features and levels. Accordingly, price normalizer 340 includes a price calculator 342 to determine the prices for such qualifying products.

Since different pricing models may be used for different vendors and product lines, price normalizer converts vendor prices to a common normalized format so that prices according to different models can be compared directly. For products with a “pay-as-you-go” pricing model, referential editions 344 (e.g., usage scenarios) embodying typical use scenarios, e.g., default scenarios, scenarios specified in a best-deal request, or taken from vendor price lists are used to generate normalized prices for comparison purposes. Price normalizer 340 may store normalization results and conversion formulae as normalization data 318 in database system 310 for use in handling future best-deal requests.

A product value calculator 350 of tool 300 calculates value multipliers and product values for qualified products. In some scenarios, a consumer may prefer the lowest-price product that meets all request features and levels, in other scenarios, a consumer may prefer to pay for a higher price alternative for which requested levels are exceeded. Also, in some scenarios, a consumer may prefer a product that does not meet all requested feature levels but has a lower price than any product that meets all requested feature levels. Product values provide for quantifying such preferences.

Value calculator 350 includes a product-feature value multiplier calculator 352 that calculates, for each combination of product and requested feature level, a product feature value multiplier (PFVM) for at least those features that are extra-sufficient or insufficient for each product. For feature levels that are minimally sufficient, the PFVM is unity (1). For feature levels that are extra-sufficient, the PFVM exceeds unity. For feature levels that are insufficient, the PFVM is less than unity.

Best-deal tool 300 attempts to order products in a way a requesting consumer would prefer them. In general, non-matching (i.e., insufficient and extra-sufficient) feature levels are characterized by diminishing returns as they deviate from the requested sufficiency level.

For example, in one scenario, a consumer wants data backup service for storing a digital picture collection. The consumer is likely to know how much capacity is needed for the collection and submits best-deal request to best-deal tool 300 for 40 GB (gigabytes) of backup space. Several backup services with various products can be compared. In this scenario, there is a product P1 that offers 40 GB for $10/month, another product P2 offers 50 GB for $11/month, and another product P3 offers 500 GB for $40/month. It is possible that the consumer would evaluate product P2 as favorable option over product P1, as the cost is only 10% higher and offered capacity is 25% higher. It is unlikely, that the consumer would find, offer product P3 to be favorable despite the favorable price per GB as it costs much more and the consumer may have no use for most of the excess storage space. Some product P4 offering 36 GB for $2/month may be also viable alternative for the user to consider.

To address the diminishing-returns character of non-matching feature levels, the PFVM for a feature can be calculated as PFVM=NLF(PFL/RFL) where NLF is a non-linear function can defined as;

NLF(x)=1+ln(x) for x≧1; and

NLF(x)=1/(1+ln(1/x)) for x<1, wherein ln is the natural logarithm.

In some examples, NLF can be any non-linear function that satisfies the following properties. First, NLF(1)=1; in other words, if PFL=RFL, in which case, the feature level is minimally sufficient, then PFVM=1. Second, NLF(0)=0; in other words, if PLF=0, PFVM=0. Third, x<y=>NLF(x)≦NLF(y); i.e., NLF is non-decreasing (monotonically increasing but possibly including some level regions). Fourth, NLF(x)=1/NLF(1/x); in other words, there is a symmetry in relative evaluations. For example, if F1 is twice as big as F2, then F2 is half as big as F1. Fifth, as a consequence of the second and fourth properties, NLF(∞)=∞; in other words, if PLF=∞, then FVM=∞. Infinite values can be converted to large but finite values to avoid infinities. Other examples use other asymmetric and other non-linear functions, e.g., other logarithmic functions or other non-decreasing, nonlinear functions.

Once the PFVMs for a product are calculated, product value multiplier calculator 354 calculates a product value multiplier (PVM) for the product by combining its PFVM's. For example, a product's PVM can equal the geometric mean of its PFVMs. Depending in part on how the PFVMs are calculated, other statistics can be used for the PVM. Once a PVM has been calculated, PVM:price ratio calculator 356 can calculate a product value (PV), e.g., as the ratio of PVM over normalized price.

Product sorter 360 sorts products at least in part based on value or other combination of feature sufficiency and normalized price. For example, product sorter 360 includes a sufficiency set sorter 362 that can sort sufficiency sets of products by sufficiency. Product sorter 360 also includes a value sorter 364 to sort product by value alone or by value within sufficiency sets. Product sorter 360 also includes a price sorter 366 that can sort by price alone or within sufficiency sets differentiated by the feature sufficiencies of the products the sets contains.

List generator 370 of tool 300 provides for generating a list of products in the order provided, by product sorter 360. The list may be dynamic in that a viewer can select among the different sortings provided. by product sorter 360. In the present case, a list 400, shown in FIG. 4, is presented initially as value sorted within sufficiency sets. In other words, products are sorted into sufficiency categories (sufficient, insufficient) and sorted according to value within categories. List 400 specifies the offer pricing model, billing details and list of features.

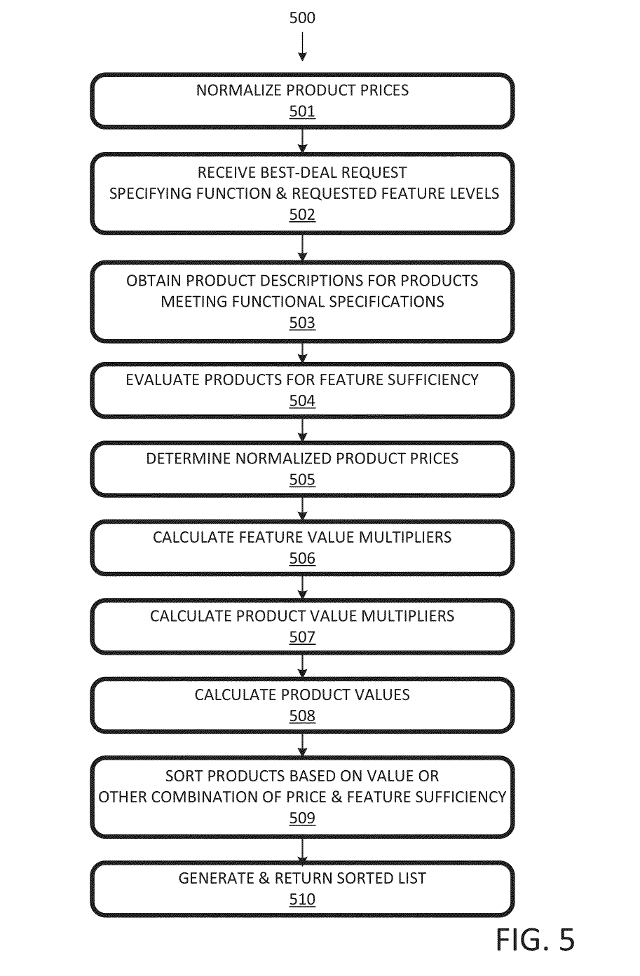

When executed by processor 302, code 308 provides for implementation of a process 500, flow-charted in FIG. 5. At 501, a hest deal request is received specifying functionality and requested feature levels. For example, 501 may specify storage space for a virtual machine. Another feature might be a level of support, e.g., 24 hours a day, 7 days a week (24/7). Another feature level might specify a price per unit, e.g., unit of storage. Another feature might specify a limit on number of emails per day. A request can conform to a feature vocabulary, e.g., maintained by a vocabulary expert, for tool 300. A request may also specify a number of accounts and a time period (e.g., in months) as part of the functional specification. The best-deal request can conform to any protocol suitable for remote queries, e.g., HTTP or SOAP.

At 502, product descriptions for products meeting the functional specifications are obtained. To view all products, the functional specification can be left empty. At 503, the products are evaluated for feature sufficiency, e.g., the extent to which requested feature levels are met, exceeded, or not met. At 504, product prices are normalized. At 505, product-feature value multipliers (PFVMs) are calculated for respective features for each product. At 506, product value multipliers (PVMs) are calculated for respective products. At 507, product multipliers are calculated. At 508, product descriptions are sorted at least in part as a function of feature sufficiency and price, e.g., as a function of value. At 509, a list with product descriptions is returned, e.g., to the consumer that submitted the request at 501. Process 500 gives priority to products that are the most efficient from the cost perspective (minimization of the price) and offer the best value (maximization of the features offered) by providing for conversion of the price to value and vice versa.

A best deal list may present products in an order based on normalized price and feature sufficiency. Alternatively, products can be sorted into sets, e.g., an “insufficient” set of products for which at least one requested feature level is not met and a “sufficient” set of products that meet all requested feature levels. The sets can be sorted so that all sufficient products are given higher priority than insufficient products; within the sets, products can be sorted by normalized price. In other example, feature sufficiency may be a factor weighed against value, rather than a primary sort factor used to completely separate products with sufficient features from products without.

Another way to sort based on normalized price and feature sufficiency is to compute product value as a function of normalized price and product feature sufficiency and then sort by product value. Another way is to sort by product sufficiency sets and then sort by product value within sets. Other alternatives involve categorizing products into more sets depending on the amount or collective extent of feature sufficiencies. Also, extra-sufficient products may be prioritized over minimally sufficient products, etc., with value or normalized price sorting within sets.

Herein, “product” encompasses goods and services, including cloud services. “Cloud services” involve on-demand network access to a shared pool of computing resources (e.g., networks, servers, storage, applications, and services) with minimal management effort or service-provider interaction. Cloud services are typically offered as “applications” that may come in multiple editions; herein, each “edition” is treated as a separate product.

Herein, a “best-deal request” is a request for product suggestions that take product features and price into account. The best-deal requests described herein specify one or more product functions and one or more product feature levels. A product or requested “function” is a mandatory characteristic of a product from the requester's perspective. A product or requested “feature” is a desired characteristic of a product from the requester's perspective. “Return”, in the context of a request, means providing results to a requester in response to the request.

Herein, a “feature level” is a quantitative specification of a feature. The units of a level depend on the feature, but are chosen such that a higher level is better. For features, e.g., response time, that are typically expressed in units where smaller is better, the feature level may be expressed in inverse units, e.g., 1/s instead of s, where “s” means “seconds”. Alternatively, an indicator may be used for feature levels in which lower values are better. A “product feature level” or “PFL” is the level of a feature provided by a product. A “requested feature level” or “RFL” is a level of a feature specified in a request, e.g., a best-deal request, desired for a suggested product; in other words, an RFL is a criterion for a PFL.

Some requested features are not conventionally quantified; in some such cases, quantitative feature levels can be assigned to the values that a feature can assume. For example, a consumer might request (but not mandate) that an email program include spell-checking. In such cases, products having the requested feature can be assigned a product-feature level of unity, while products lacking the requested feature can be assigned a product-feature level of zero.

Herein, “feature sufficiency” regards a degree to which a product feature level (PFL) meets a requested feature level (RFL). There are alternative ways to express feature sufficiency including: as a dichotomy (insufficient vs. sufficient); as a trichotomy (insufficient v. minimally sufficient v. extra-sufficient), or as a ratio (PFL/RFL). “Minimally sufficient” implies RFL=PFL either exactly or within some specified tolerance.

Herein, a “product-feature value multiplier” or “PFVM” is a coefficient corresponding to an increased value for a product due to extra-sufficiency of a product feature or a decreased value for a product due to insufficiency of a product feature. The ratio PFL/RFL is a metric for a product-feature multiplier. A “product value multiplier” or “PVM” represents an increase or decrease in a product's value due to the combined PFVMs for the product. A “product value” is a measure of a product's value based on its (normalized) price and its product value multiplier. The ratio PVM/price is a metric for product value. Note that product value is a function of both feature sufficiency and normalized price.

Herein, “price” is a monetary amount associated with a product purchase (including subscriptions and licenses). Herein, prices include vendor pricelist prices and normalized prices. A “pricelist price” is a vendor price given a respective pricing model, whether or not that price is actually listed in a pricelist as such. Since products are priced using different pricing models, pricelist prices for different products may not be readily comparable.

Herein, “normalization” is a process in which the form of one or more values is converted so that the values in the set are more readily comparable. In the present context, “normalized values” implies that at least one product price has been converted from its vendor (e.g., pricelist or catalog) price. Note that if one price is converted, the other prices in the set are “normalized” even if they remain the same as the vendor prices. Herein, “list” encompasses: tables in which information is arranged in rows and columns; and non-tabular lists.

Herein, a “system” is a set of interacting non-transitory tangible elements, wherein the elements can be, by way of example and not of limitation, mechanical components, electrical elements, atoms, physical encodings of instructions, and process segments. Herein, “process” refers to a sequence of actions resulting in or involving a physical transformation. “Storage medium” and “storage media” refer to a system including non-transitory tangible material in or on which information is or can be encoded so as to be readable by a computer. “Computer-readable” refers to storage media in which information is encoded in computer-readable form. Herein, a “processor” is a hardware device, a hardware component of a hardware device, or a combination of hardware devices configured to execute computer-executable code encoded in media.

In this specification, related art discussed for expository purposes. Related art labeled “prior art”, if any, is admitted prior art. Related art not labeled “prior art” is not admitted prior art. In the claims, “said” refers to claim elements for which there is explicit verbatim antecedent basis, while “the” refers to claim elements for which antecedent basis may be implicit. Unless otherwise explicitly limited, functional definitions of programmed hardware components and code encoded in media are intended to encompass, respectively, all forms of programmed hardware and all forms of code encoded in media. The illustrated and other described embodiments, as well as modifications thereto and variations thereupon are within the scope of the following claims.

What is claimed is:

1. A computer-implemented process comprising:
in response to receipt of a best-deal request specifying requested feature levels for products, evaluating feature sufficiency for each of said products, each feature sufficiency indicating whether or not a given product meets a respective one of said requested feature levels;
determining normalized prices for said products;
sorting said products based at least in part on respective feature sufficiencies and respective prices so as to determine an order for said products; and
generating a best-deal list of said products in which product identifiers for said products are arranged in said order.

2. A process as recited in claim 1 wherein said sorting includes:
sorting sets of said products, said sets corresponding to different feature sufficiency levels; and
sorting products within each of said sets based at least in part on price.

3. A process as recited in claim 1 further comprising:
for each combination of product and requested feature level, determining a feature value multiplier as a function of said requested feature level and a level at which the respective product has of that feature;
for each product, determining a value multiplier by combining its feature value multipliers; and
for each product, determining a product value as a function of its value multiplier and its price;
wherein said sorting involves sorting at least some of said products according to their respective product values.

4. A process as recited in claim 3 wherein said combining includes calculating a geometric mean.

5. A process as recited in claim 1 wherein said determining normalized prices includes using referential usage scenarios for products subject to pay-as-you-go pricing plans.

6. A programmed hardware best-deal tool comprising:
an interface for receiving a best-deal request specifying requested feature levels (RFLs);
a feature comparator to evaluate product feature sufficiency for each of plural products by comparing product feature levels (PFLs) of said products with said RFLs;
a price normalizes to provide normalized prices for said products based at least in part on catalog prices for said products;
a product sorter to sort said products in an order at least in part based on feature sufficiency and normalized price; and
a list generator to generate and return a best-deal list of said products in said order.

7. A best-deal tool as recited in claim 6 further comprising:
a value calculator including
a product-feature value multiplier calculator to calculate a product feature value multiplier based on a respective feature sufficiency for each combination of product and requested feature;
a product-value multiplier calculator to calculate a product value multiplier based on the product feature value multipliers for each product; and
a value multiplier over price ratio calculator to calculate, for each product, a product value based on the respective product value multiplier and the respective normalized price for each. product; and
said product sorter being to sort products at least in part product value.

8. A best-deal tool as recited in claim 6 wherein said value sorter includes:
a sufficiency set sorter to categorize products into sets based on feature sufficiency and to sort said sets according to feature sufficiency; and
a price sorter to sort within at least one of said sets based on normalized price.

9. A best-deal tool as recited in claim 6 wherein said price normalizer is configured to use referential editions to normalize catalog prices based on a pay-as-you-go pricing model.

10. A best-deal tool as recited in claim 6 further comprising a function filter for selecting products that meet a function specified in said request for feature comparison by said feature comparator.

11. A system comprising computer-readable storage media encoded with code that, when executed by a processor, defines functionality for:
a feature comparator to determine feature sufficiencies for respective products by comparing requested feature levels with product feature levels;
a price normalizer to normalize vendor prices for products to increase their comparability;
a product sorter to sort products into an order at least in part based on a combination of normalized price and feature sufficiency; and
a list generator to generate a best-deal list of products in said order.

12. A system as recited in claim 11 further comprising said processor.

13. A system as recited in claim 11 wherein said code further defines a product value calculator for calculating product values for respective products based on normalized price and feature sufficiencies, said product sorter sorting products according to product value.

14. A system as recited in claim 11 wherein said sorter is further to sort sufficiency sets of said products and sort products according to value within said sets, said sufficiency sets being differentiated based on feature sufficiencies of the products included in the respective sets.

15. A system as recited in claim 11 wherein said code further defines a functional filter for filtering out products not meeting functional specifications set forth in a best-deal request.
